(19) United States
(12) Patent Application Publication
(10) Pub. No.: US 2020/0097972 A1
(43) Pub. Date: Mar. 26, 2020

(54) ELECTRONIC DEVICE AND COMPUTERIZED METHOD FOR PERFORMING PAYMENT TRANSACTIONS

(71) Applicant: Mastercard International Incorporated, Purchase, NY (US)

(72) Inventors: Ajit Karnik, Pune (IN); Ajay Sinha, Pune (IN)

(73) Assignee: Mastercard International Incorporated, Purchase, NY (US)

(21) Appl. No.: 16/530,074

(22) Filed: Aug. 2, 2019

(30) Foreign Application Priority Data
Sep. 24, 2018 (SG) 10201808295V

(51) Int. Cl. G06Q 20/40; G06Q 20/20; G06Q 20/22

(52) U.S. Cl. CPC G06Q 20/4014; G06Q 20/227; G06Q 20/206

(57) ABSTRACT

The present disclosure generally relates to an electronic device and computerized method for performing a payment transaction between a user and a payee using a payment application operative on the electronic device for performing the method. The method includes initiating a user request to perform the payment transaction; presenting a user operative interface for the user to provide details of the payment transaction; obtaining the payment transaction details comprising payee identification data and a payment amount; and selecting a payment instrument of the user for payment of the payment amount to the payee. The method further includes generating a payment request comprising the payment transaction details and selected payment instrument details; and communicating the payment request to a payment network for subsequent processing of the payment transaction, wherein the payment application provides a plurality of options for the user to provide the payee identification data.

### CROSS REFERENCE TO RELATED APPLICATIONS

This application claims priority to Singaporean Application Serial No. 10201808295V, filed Sep. 24, 2018, which is incorporated herein by reference in its entirety

### TECHNICAL FIELD

The present disclosure generally relates to performing of payment transactions. Particularly, the present disclosure describes various embodiments of an electronic device and computerized method for performing payment transactions between a user of the electronic device and a payee, which can be a merchant or another user. More particularly, the electronic device provides a payment application for performing the payment transactions, and which may be a standalone application or integrally installed as part of the electronic device's operating system.

### BACKGROUND

Currently, various forms of digital payments and online payments are increasingly being used for performing payment transactions. Whether it is online money transfer, bill payment, shopping, online ticket booking, tap and pay on a transit, or payments of any other kind, digital payment has become integral part of all payment transactions. The final step common to all these payment transactions is to transfer money between two or more entities, e.g. from customer to merchant. The basic details or data elements required for making a payment are payee identity, amount to pay, date of payment, and payment mode. However, many payment applications, such as those provided by banks and merchants, are bloated with additional features which, though useful for other use cases, are not required for the express purpose of making a payment, thereby making the final payment step a lot more cumbersome than it should be. These additional features, as mentioned above, may offer the user some information which may be relevant to the banks for promoting their products and services, but are less relevant to the user who only wants to make a payment across the counter or online, especially when the payment needs to be completed within a limited time otherwise the payment session may expire. Further, every payment application has its own shortcut or icon which clutters the screen of a user's mobile device, making it difficult for the user to locate particular payment applications which can only be used for certain types of payment transactions, such as to particular merchants. In addition, given that there are no known or established standards, payment applications from various banks offer different user interfaces, and also executes the transaction flow in different ways which may be cumbersome to use.

U.S. Pat. No. 8,332,272 discloses a “Buy Now” button on customer mobile device, by pressing which the customer's payment credentials can be transferred to a merchant website. United States patent publication 20170169420 discloses making an online transaction or point-of-sale (POS) transaction by a user via a merchant website or terminal and receiving a transaction approval request at the user's mobile device. U.S. Pat. No. 5,960,411 discloses “a single click” or “a single action” purchase by a user on a merchant website. The merchant server performs all relevant actions for processing the purchase. However, in the above, the payment transactions are processed at the merchant end and the user has limited control of the payment transaction details using his/her mobile device, including payee identity and payment amount.

Therefore, in order to address or alleviate at least one of the aforementioned problems and/or disadvantages, there is a need to provide an improved electronic device and computerized method for performing payment transactions.

### SUMMARY

According to an aspect of the present disclosure, there is an electronic device, a computerized method, and a non-transitory computer-readable storage medium comprising instructions for performing a payment transaction between a user and a payee. The electronic device configured for executing a payment application operative on the electronic device. The payment application comprises a transaction request module and a payment request module configured for performing steps of the method.

The transaction request module is configured for: initiating a user request to perform the payment transaction; presenting, in response to initiation of the user request, a user operative interface for the user to provide details of the payment transaction; obtaining, via the user operative interface, the payment transaction details comprising payee identification data and a payment amount; and selecting, by the user via the user operative interface, a payment instrument of the user for payment of the payment amount to the payee.

The payment request module configured for: generating a payment request comprising the payment transaction details and selected payment instrument details; and communicating the payment request to a payment network for subsequent processing of the payment transaction, wherein the user operative interface provides a plurality of options for the user to provide the payee identification data.

An electronic device and computerized method for performing payment transactions, according to the present disclosure are thus disclosed herein. Various features, aspects, and advantages of the present disclosure will become more apparent from the following detailed description of the embodiments of the present disclosure, by way of non-limiting examples only, along with the accompanying drawings briefly described below.

### BRIEF DESCRIPTION OF THE DRAWINGS

FIG. 1 is an illustration of an electronic system for performing payment transactions, in accordance with embodiments of the present disclosure.

FIG. 2 is a flowchart illustration of a computerized method implemented on an electronic device for performing payment transactions, in accordance with embodiments of the present disclosure.

FIG. 3A to FIG. 3G are illustrations of graphical user interfaces of the electronic device during said performing of payment transactions, in accordance with embodiments of the present disclosure.

FIG. 4 is a schematic illustration of a computerized method implemented on the electronic device for performing a payment transaction between a user and a merchant using a payment application, in accordance with embodiments of the present disclosure.

FIG. 5 is a schematic illustration of a computerized method implemented on the electronic device for performing a payment transaction between a user and another user using a payment application, in accordance with embodiments of the present disclosure.

FIG. 6 is a schematic illustration of a computerized method implemented on the electronic device for performing a payment transaction between a user and a merchant using a merchant application, in accordance with embodiments of the present disclosure.

FIG. 7 is a schematic illustration of a computerized method implemented on the electronic device for performing a QR code-based payment transaction between a user and a merchant, in accordance with embodiments of the present disclosure.

FIG. 8 is a schematic illustration of a computerized method implemented on the electronic device for performing an NFC-based payment transaction between a user and a merchant, in accordance with embodiments of the present disclosure.

FIG. 9 is a block diagram illustration of the technical architecture of the electronic device, in accordance with embodiments of the present disclosure.

### DETAILED DESCRIPTION

In the present disclosure, depiction of a given element or consideration or use of a particular element number in a particular figure or a reference thereto in corresponding descriptive material can encompass the same, an equivalent, or an analogous element or element number identified in another figure or descriptive material associated therewith. The use of “I” in a figure or associated text is understood to mean “and/or” unless otherwise indicated. For purposes of brevity and clarity, descriptions of embodiments of the present disclosure are directed to an electronic device and computerized method for performing payment transactions, in accordance with the drawings. While aspects of the present disclosure will be described in conjunction with the embodiments provided herein, it will be understood that they are not intended to limit the present disclosure to these embodiments. On the contrary, the present disclosure is intended to cover alternatives, modifications and equivalents to the embodiments described herein, which are included within the scope of the present disclosure as defined by the appended claims. Furthermore, in the following detailed description, specific details are set forth in order to provide a thorough understanding of the present disclosure. However, it will be recognized by an individual having ordinary skill in the art, i.e. a skilled person, that the present disclosure may be practiced without specific details, and/or with multiple details arising from combinations of aspects of particular embodiments. In a number of instances, known systems, methods, procedures, and components have not been described in detail so as to not unnecessarily obscure aspects of the embodiments of the present disclosure.

### Overview

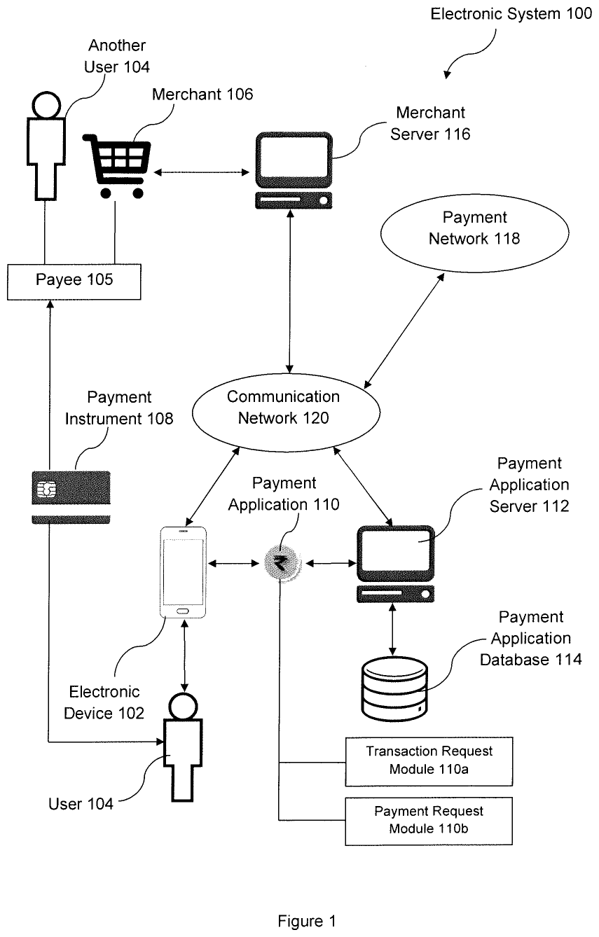

In representative or exemplary embodiments of the present disclosure, there is an electronic or computer system 100 including an electronic device 102 of a user 104 for performing a payment transaction between the user 104 and a payee 105, as illustrated in FIG. 1. In many embodiments of the present disclosure, the payee 105 is a merchant 106. However, in some embodiments, the payee 105 can be another user 104 using another electronic device 102 for payment transactions between users 104. The merchant 106 may be a business or commercial entity that offers merchandise for purchase by the consumer 106. The merchant 106 may operate an online business establishment and/or a physical retail store. The merchant 106 may alternatively be a transport service provider, such as a public metro/train/bus service which the user 104 may use for commute. The electronic device 102 can be used by the user 104 to perform various payment transactions with the merchant 106, including making payments to the merchant 106 using a payment instrument 108, such as a credit card. Particularly, a software or mobile payment application 110 is executable on the electronic device 102 for performing the payment transactions. The system 100 further includes a payment application server 112 that remotely hosts the payment application 110 and with which the electronic device 102 is communicable for operating the payment application 110. User data of users 104 of the payment application 110 may be stored on a payment application database 114 accessible by the payment application server 112. The user data may include user login credentials and details of pre-registered payment instruments 108 of the users 104. The system 100 further includes a server 116 of the merchant 106 and a payment network 118 for processing the payment transactions. The electronic device 102, payment application server 112, merchant server 116, and payment network 118 are communicable with one another through a communication network 120. It will be appreciated that the payment network 118 includes or is communicatively linked to various financial entities and their computing systems/servers, including issuer institutions/banks, acquirer institutions/banks, and the like.

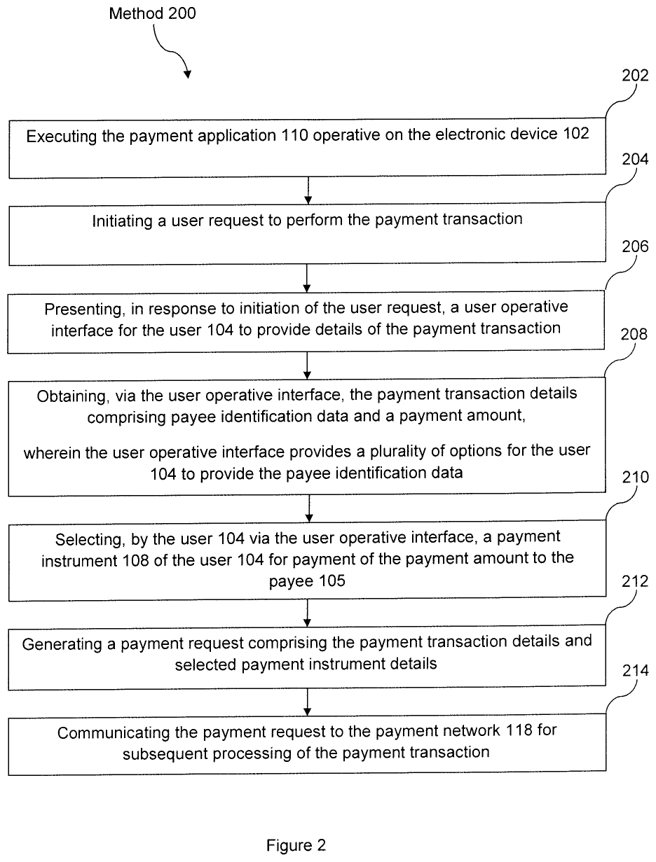

With reference to FIG. 2, there is shown a computer-implemented or computerized method 200 implemented on the electronic device 102 for performing the payment transaction. The electronic device 102 is configured for executing the payment application 110 installed on the electronic device 102. The payment application 110 includes various software application modules for performing various steps or operations of the method 200, including a transaction request module 110a and payment request module 110b.

In an exemplary scenario, the user 104 intends to pay some bills to the payee 105 which may be a utilities merchant 106. In a step 202 of the method, the electronic device 102, specifically a processor thereof, executes the payment application 110 to thereby perform additional steps of the method 200. The payment application 110 may be executed in response to user activation of a payment application icon displayed on the home screen of the electronic device 102, as with the default “Phone” and “Messages” application icons, etc.

In a step 204, the transaction request module 110a of the payment application 110 initiates a user request to perform the payment transaction. The user request may include user login credentials to verify the user's identity to use the payment application 110. In a step 206, the transaction request module 110a presents, in response to initiation of the user request, a user operative interface for the user 104 to provide details of the payment transaction. In a step 208, the transaction request module 110a obtains details of the payment transaction provided by the user 104 via the user operative interface. The payment transaction details include identification data of the payee 105 and a payment amount. The user 104 provides the payment transaction details by inputting them into the payment application 110. Additionally, the payment application 110, specifically on the user operative interface, provides a plurality of options for the user 104 to provide the payee identification data. The plurality of options may relate to one or more of optical codified data (e.g. Quick Response (QR) codes), contacts stored on the electronic device 102, transaction history, and proximity to the user 104. For example, the payee identification data may be obtained by scanning a QR code with the electronic device 102 or manually entered by the user 104. In a step 210, the transaction request module 110a selects, by the user and via the user operative interface, a payment instrument 108 of the user 104 for payment of the payment amount to the payee 105. The payment instrument 108 may be selected by the user 104 from pre-registered payment instruments 108 of the user 104.

In a step 212, the payment request module 110b of the payment application 110 generates a payment request including the payment transaction details and details of the selected payment instrument 108. In a step 214, the payment request module 110b communicates the payment request to the payment network 118 for subsequent processing of the payment transaction. Specifically, the electronic device 102 communicates the payment request to the payment application server 112 which in turn communicates the payment request to the payment network 118, such as to the issuer institution/bank of the selected payment instrument 108. Upon completion of said processing of the payment transaction, the payment amount is transferred from the selected payment instrument 108 to an account of the payee 105. It will be appreciated that the payment transaction is processed by the payment network 108 in a standard manner readily understood by the skilled person.

Accordingly, the electronic device 102 and method 200 advantageously provides a payment application 110 that is versatile for the user 104 to perform payment transactions with various payees 105, particularly merchants 106. The user 104 provides, via the user operative interface, the payment transaction details including the merchant identification data and payment amount, as well as details of a selected payment instrument 108 for payment of the payment transaction. The basic details required for making payment in all payment transactions are provided by the user 104. The payment application 110 thus shifts control of parameters of payment transactions from the merchants 106 to the users 104 and empowers the users 104 with greater flexibility in payment transactions. Various options are provided by the payment application 110 on the user operative interface to help the user 104 provide the payee identification data, thereby simplifying the process of performing payment transactions. The user 104 can thus use the payment application 110 to perform payment transactions without much complexity and confusion.

### Description of Embodiments

References to “an embodiment/example”, “another embodiment/example”, “some embodiments/examples”, “some other embodiments/examples”, and so on, indicate that the embodiment(s)/example(s) so described may include a particular feature, structure, characteristic, property, element, or limitation, but that not every embodiment/example necessarily includes that particular feature, structure, characteristic, property, element or limitation. Furthermore, repeated use of the phrase “in an embodiment/example” or “in another embodiment/example” does not necessarily refer to the same embodiment/example.

The terms “comprising”, “including”, “having”, and the like do not exclude the presence of other features/elements/steps than those listed in an embodiment. Recitation of certain features/elements/steps in mutually different embodiments does not indicate that a combination of these features/elements/steps cannot be used in an embodiment.

As used herein, the terms “component”, “module,” “system”, “apparatus”, “interface”, and the like are generally intended to refer to a computer-related entity, either hardware, a combination of hardware and software, software, or software in execution. For example, a component or a module may be, but is not limited to being, a process running on a processor, a processor, an object, an executable, a thread of execution, a program, and/or a computer. By way of illustration, both an application running on a controller and the controller can be a component/module. One or more components/modules may reside within a process and/or thread of execution. A component/module may be localized on one computer and/or distributed among a plurality of computers.

As used herein, the terms “a” and “an” are defined as one or more than one. The term “set” is defined as a non-empty finite organization of elements that mathematically exhibits a cardinality of at least one (e.g. a set as defined herein can correspond to a unit, singlet, or single-element set, or a multiple-element set), in accordance with known mathematical definitions. The recitation of a particular numerical value or value range herein is understood to include or be a recitation of an approximate numerical value or value range.

While various terms as used in representative or exemplary embodiments of the present disclosure are defined herein, the definitions of these terms are not intended to be limited as such and are in addition to their plain meanings according to standard English dictionaries.

In various embodiments of the present disclosure, the electronic system 100 includes the electronic device 102 for performing a payment transaction between the user 104 and the payee 105, such as a merchant 106 or another user 104. The system 100 further includes the payment application server 112, merchant server 116, and payment network 118, wherein one or more or all of which are communicable with one another through the communication network 120.

The payment network 118 refers to a payment network for various payment instruments 108 and which is operated by an intermediary entity. Typically, the intermediary entity is a card association, such as a credit card association, that facilitates communications between acquirer institutions and issuer institutions to authorize and pay for transactions performed using the payment instruments 108. The payment network 118 settles the transactions between various acquirer institutions and issuer institutions, when payment instruments 108 such as credit cards are used for payment of transactions between users 104 and payees 105. Some examples of payment networks operated by intermediary entities include the Banknet payment network operated by Mastercard®. The payment network may be integrated with or complements the communication network 120 to facilitate processing of payment transactions. The payment network 118 generates credit/debit notifications or messages based on processing of a payment transaction. The credit/debit notifications are communicated to the acquirer and issuer institutions for crediting/debiting the respective accounts corresponding to the payment transaction. More specifically, upon processing of the payment transaction, funds are debited from the payment instrument 108 of the user 104, and funds are credited to an account of the payee 105 held at the acquirer institution.

The user 104 is an individual who is an account holder of an account associated with a number of payment instruments 108 of the user 104. In some embodiments, the account is a bank account maintained by a financial institution, such as an issuer institution or bank. In some other embodiments, the account is a digital wallet maintained by a merchant 106, the intermediary entity, an issuer institution or bank, or a third-party service provider. The account may be linked to a payment instrument 108 and thus the payment instrument 108 stores identification information of the account. The account identification information may be stored in the form of an electronic chip or a machine-readable magnetic strip embedded in the payment instrument 108, such as a credit card or debit card. The account identification information may include an account number and the name of the account holder (i.e. user 104). The payment instrument 108 has a unique identifier, an expiry date, security data, and type. The payment instrument identifier, expiry date, security data, and type constitute details of the consumer payment instrument 108.

The payment instrument 108 refers to any suitable cashless payment mechanism, such as payment cards or transaction cards, which the user 104 may use to perform transactions, such as deposits and withdrawals, credit transfers, merchandise purchase, payment transactions, and the like. In some embodiments, the payment instrument 108 is a physical card, such as credit card, debit card, membership card, promotional card, contactless card, charge card, frequent flyer card, gift card, prepaid card, or the like. The payment instrument 108 may be radio frequency identification (RFID) or near field communication (NFC) enabled for performing contactless payment transactions. In some other embodiments, the payment instrument 108 is stored electronically in memory of the electronic device 102, such as on an application or digital wallet resident or operative on the electronic device 102.

The electronic device 102 enables the user 104 to perform payment transactions with payees 105, such as with merchants 106 for commute, bill payments, and merchandise purchase. The payment transactions may occur through e-commerce interfaces (e.g. card-not-present payment transactions at merchant websites or other software/mobile applications) or at a point-of-sale (POS) terminal (e.g. physical in-store payment transactions) associated with the merchant 106. The electronic device 102 may be a mobile device, mobile phone, smartphone, personal digital assistant (PDA), key fob, transponder device, NFC-enabled device, tablet, phablet, laptop, computer, other communication device, or the like.

The merchant 106 is a business or commercial entity that offers various merchandise, including goods, products, and services, in exchange for payments. The merchant 106 may establish an account with a financial institution, such as an acquirer institution or bank to accept the payments from users 104 by use of the payment instruments 108. Alternatively, the merchant 106 may establish an account with a payment aggregator which provides a service for merchants to process payment transactions. The merchant 106 operates the merchant server 116 that is a computer server associated with a merchant apparatus/billing machine or a POS terminal in a merchant's retail premises, or an e-commerce interface on which payment transactions can be initiated by the users 104.

As used herein, the term “account” refers to any form of arrangement that a user 104/merchant 106 has with an institution that allows the user 104/merchant 106 to deposit/withdraw funds. An account can be a deposit account, a credit card account, a debit card account, a current account, a saving account, an overdraft account, a trading account or any other type of account offered by the institution. Furthermore, the account may be a loan account in which case the user 104/merchant 106 owes money to the institution. The term “institution” is not necessarily limited to organizations which are legally constituted as banks. In some jurisdictions or countries, other organizations may be permitted to maintain financial accounts such as a payment card account. An institution may thus be one of the following: a bank, financial technology company, and financial institution. It will be appreciated that the acquirer and issuer institutions/banks receive various credit and debit notifications/messages from the payment network 118. Based on the credit and debit notifications, the acquirer institution credits the merchant account and issuer institution debits the user account or payment instrument 108 linked thereto. It will be further appreciated that said crediting and debiting via the acquirer and issuer institutions will be readily apparent to the skilled person and may include processing via the conventional four-party system or three-party system.

The communication network 120 is a medium or environment through which content, notifications, and/or messages are communicated among various entities, including the electronic device 102, payment application server 112, merchant server 116, and payment network 118. Some non-limiting examples of the communication network 120 include a virtual private network (VPN), wireless fidelity (Wi-Fi) network, light fidelity (Li-Fi) network, local area network (LAN), wide area network (WAN), metropolitan area network (MAN), satellite network, Internet, fiber optic network, coaxial cable network, infrared (IR) network, radio frequency (RF) network, and any combination thereof. Various entities in the communication network 120 may connect to the communication network 120 in accordance with various wired and wireless communication protocols, such as Transmission Control Protocol/Internet Protocol (TCP/IP), User Datagram Protocol (UDP), 2nd to 5th Generation (2G to 5G) communication protocols, Long Term Evolution (LTE) communication protocols, and any combination thereof. Each of the electronic device 102, payment application server 112, merchant server 116, as well as various computing systems/servers of the payment network 118, includes a data communication or transceiver module to communicate and transmit/receive data over the communication network 120. Some non-limiting examples of a transceiver module include an antenna module, a radio frequency transceiver module, a wireless transceiver module, a Bluetooth transceiver module, an Ethernet port, a Universal Serial Bus (USB) port, or any other module/component/device configured for transmitting and receiving data.

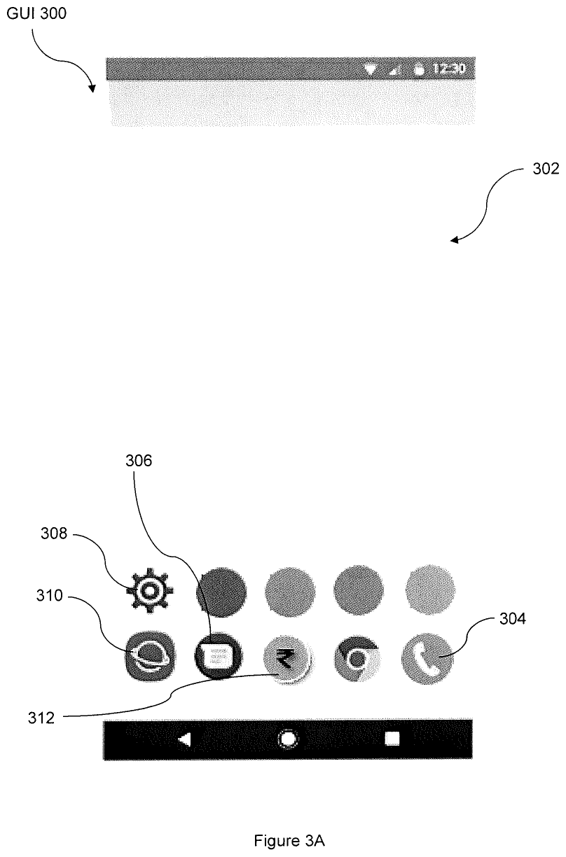

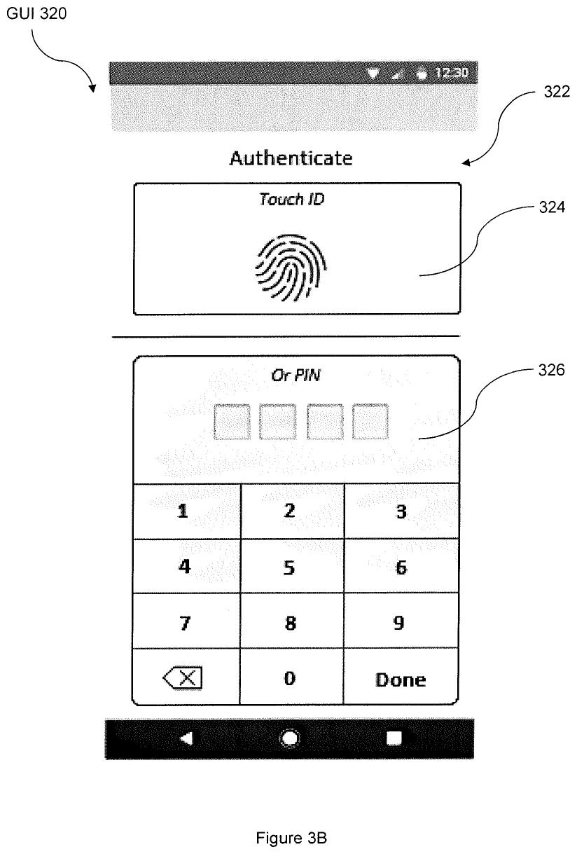

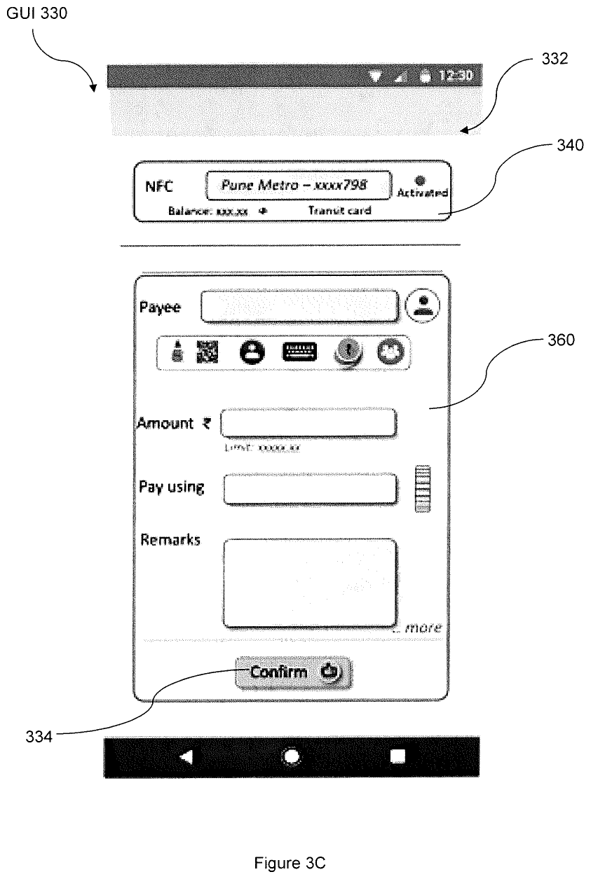

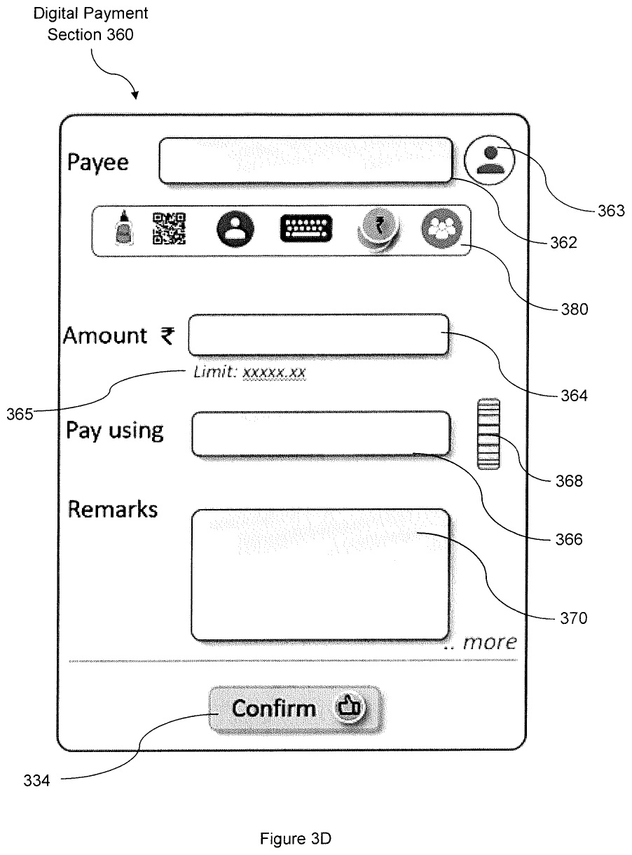

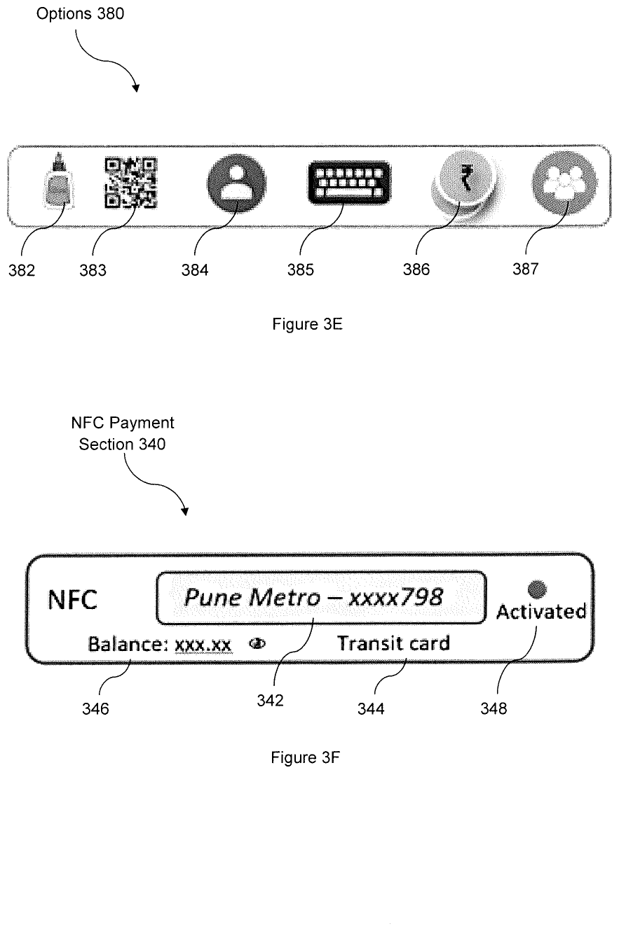

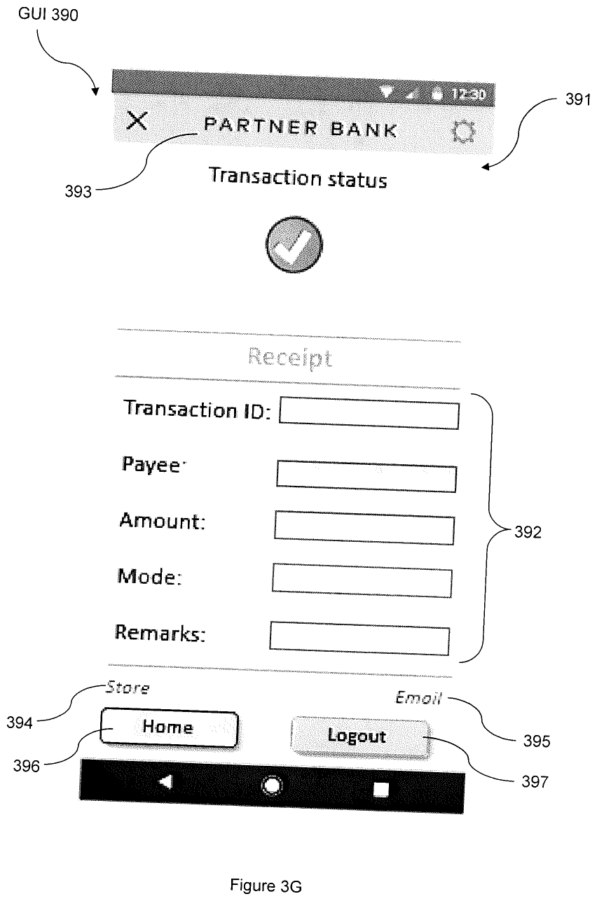

In various embodiments, the method 200 for performing payment transactions is performed by the electronic device 102, and specifically by execution of the payment application 110 thereon, for various types of payment transactions between the user 104 and payees 105 including merchants 106. FIG. 3A to FIG. 3D illustrate various screenshots of graphical user interfaces (GUIs) of the electronic device 102 when using the payment application 110.

FIG. 3A depict a GUI 300 representing a home screen or home menu 302 of the operating system of the electronic device 102. The home screen 302 has various application icons for accessing various applications operative on the electronic device 102. For example, the home screen 302 includes a “Phone” application icon 304, “Messages” application icon 306, “Settings” application icon 308, and “Internet” application icon 310. Usually, application icons displayed on the home screen 302 represent default or frequently-used applications of the electronic device 102, and the applications associated with these application icons typically come with and are integrally operative as part of the operating system. The home screen 302 may include a payment application icon 312 for executing the payment application 110. Placing the payment application icon 312 on the home screen 302 advantageously helps the user 104 to easily locate and conveniently access the payment application 110. Alternatively, the payment application icon 312 may be moved by the user 104 to another folder or sub-folder accessible within the home screen 302 or via an application main menu of the operating system. In some embodiments, the payment application comes with and is integrally operative as part of the operating system. The payment application 110 can be executed in response to user activation, e.g. by tapping, of the payment application icon 312 displayed on the GUI 300, such as on the home screen 302 or another folder/sub-folder. In some other embodiments, the payment application 110 is a standalone application and is cooperative, via an application programming interface (API), with a number of other applications operative on the electronic device 102. The other applications may include a merchant application hosted on the merchant server 116 that enables payment transactions with a particular merchant 106, and a digital wallet application that enables payment transactions with a variety of merchants 106, such as for bill payments to different utilities companies. The payment application 110 can be executed in response to processing user input via the other applications. For example, the other applications may implement the payment rails or services provided by the payment application 110 to facilitate performing of payment transactions via the other applications. Specifically, the other applications may provide a function at the checkout page that enables access to, or operations of, the payment application 110.

The user request for initiating a payment transaction with a payee 105 is generated in response to execution of the payment application 110. In some embodiments, the user request may include user login credentials to verify the user's identity to use the payment application 110. FIG. 3B depicts a GUI 320 representing a user credentials screen 322. The user credentials screen 322 includes one or more verification schemes for verifying the identity of the user 104 accessing the payment application 110. Specifically, the user 104 inputs user login credentials to verify whether the user 104 is a rightful or authorized user of the payment application 110. The verification schemes may include a biometric verification scheme 324 and/or a code verification scheme 326, and verified access to the payment application 110 may be based on one or both verification schemes 324 and 326. The biometric verification scheme 324 may be based on fingerprint scanning. In this regard, the display screen of the electronic device 102 is configured for scanning fingerprints. The biometric verification scheme 324 may be based on other biometric parameters, such as facial, retinal image, and/or speech recognition. The code verification scheme 326 may be based on a numerical PIN code or more complex alphanumeric passcodes. The code verification scheme 326 may also be based on pattern locks. If the verification fails, then use of the payment application 110 is denied and the user request is rejected. Conversely, upon successful verification, the user request is approved and the user 104 will be allowed use the payment application 110 to perform the payment transaction.

Successful verification of the user credentials directs the user 104 to further access of the payment application 110 and to process the user request for performing the payment transaction. Specifically, the payment application 110 presents, in response to initiation of the user request and successful verification of the user credentials, a user operative interface for the user 104 to provide details of the payment transaction. In many embodiments, the user operative interface is illustrated in FIG. 3C as a GUI 330 representing a payment transaction screen 332. The user operative interface provides the user 104 with various options and fields to provide the payment transaction details, and may also be referred to as the GUI 330 or payment transaction screen 332. At the payment transaction screen 332, the user 104 provides payment transaction details including payee identification data and payment amount, as well as details of the payment instrument 108 for paying the payee 105. The payee identification data may include, but is not limited to, one or more of the name, address, contact number, and/or account number of the payee 105. The payment transaction screen 332 includes an NFC payment section 340 and a digital payment section 360. FIGS. 3D to FIG. 3F illustrate more details of the NFC payment section 340 and digital payment section 360, which are described further below. Upon providing and inputting of the payment transaction details and payment instrument details at the digital payment section 360, the user 104 activates or taps on the “Confirm” icon 334 for further processing of the payment transaction. Specifically, the payment application 110 generates a payment request that includes the payment transaction details and payment instrument details. The electronic device 102 communicates the payment request to the payment network 118, such as via the payment application server 112, for subsequent processing of the payment transaction.

After the payment transaction is successfully processed by the payment network 118, the payment application server 112 receives a payment response from the payment network 118 that confirms transfer of the payment amount from the payment instrument 108 to an account of the payee 105. The payment application server 112 then communicates the payment response to the electronic device 102. FIG. 3G depicts a GUI 390 representing a payment response screen 391. The payment response screen 391 informs the user 104 that the payment transaction has been successfully processed (or has failed in some other situations). The payment response screen 391 may include payment receipt details 392 that are consistent with the payment transaction details and payment instrument details from the digital payment section 360 of the preceding payment transaction screen 332. The payment receipt details 392 may additionally include an identifier of the processed payment transaction. The payment response screen 391 may display an identifier 393 of the issuer institution of the payment instrument 108. The payment response screen 391 may further provide options for the user 104 to store 394 the payment receipt details 392, such as on a storage device of the electronic device 102 and/or on the payment application database 114, or to email 395 the payment receipt details 392 to an email address of the user 104. The payment application database 114 may reside locally on the payment application server 112, or alternatively on a remote or cloud server communicatively linked to the payment application server 112. Subsequently, the user 104 may return to home 396 of the payment application 110, such as to perform another payment transaction, or logout 397 of the payment application 110.

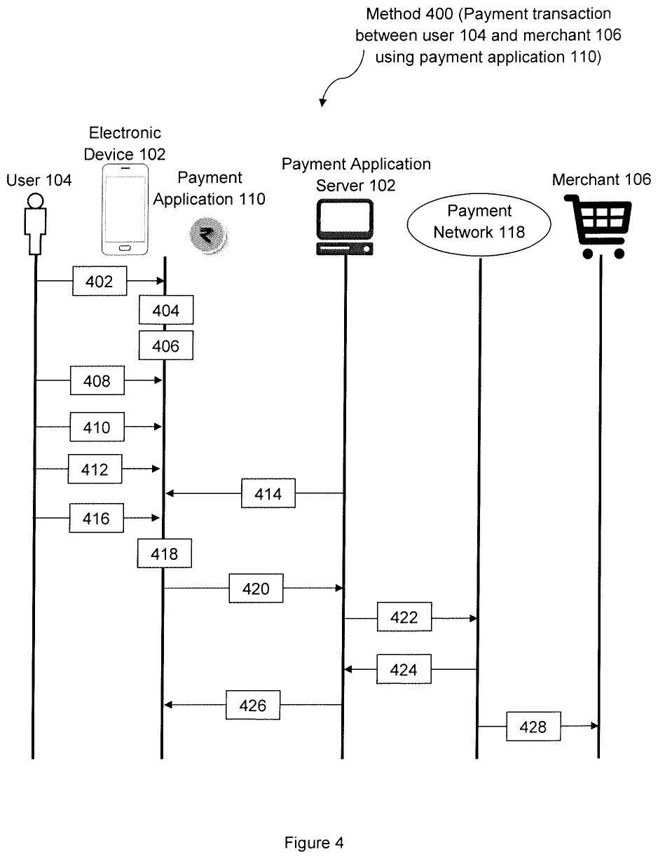

In some embodiments with reference to FIG. 4A, there is a computerized method 400 implemented on the electronic device 102 for performing a payment transaction between a user 104 and a payee 105. The user 104 intends to pay some bills to the payee 105 which may be a utilities merchant 106. In a step 402 of the method 400, the user 104 activates the payment application icon 312 displayed on a GUI of the electronic device 102 to thereby execute the payment application 110. In a step 404, the transaction request module 110a of the payment application 110 initiates a user request to perform the payment transaction. Optionally, the user request includes user login credentials for verifying the user 104. In a step 406, the transaction request module 110a presents, in response to initiation of the user request, a user operative interface for the user 104 to provide details of the payment transaction. The user operative interface is depicted as the GUI 330 representing the payment transaction screen 332. In a step 408, the transaction request module 110a obtains the payment transaction details provided by the user 104 via the user operative interface. Specifically, the user 104 provides the payment transaction details at the digital payment section 360 of the payment transaction screen 332.

In a step 410, the user 104 provides the identification data of the merchant 106. With reference to FIG. 3D, the digital payment section 360 includes a payee field 362 for inputting the merchant identification data. The user operative interface provides a plurality of options 380 for the user 104 to provide the merchant identification data. The plurality of options 380 are listed in the digital payment section 360 of the payment transaction screen 332 for inputting the merchant identification data. A shortcut 363 may be provided next to the payee field 362 for the most frequently used among the options 380. The digital payment section 360 further includes a payment amount field 364 for the user 104 to input the payment amount, and a payment mode field 366 for selecting a payment instrument 108 of the user 104 for payment to the merchant 106. The digital payment section 360 may include a selector 368 to facilitate selection of the payment instrument 108, such as a scroll wheel to scroll through a set of pre-registered payment instruments 108. The digital payment section 360 may include a remarks field 370 for the user 104 to provide remarks or comments pertaining to the payment transaction, such as to inform the merchant 106 a user account number associated with the bill payments.

With reference to FIG. 3E, the options 380 for inputting the merchant identification data include a “Paste QR” option 382 and a “Scan QR” option 383 for capturing QR codes. In this regard, the merchant identification data may be embedded in and obtained from optical codified data including QR codes. It will be appreciated that there are other forms of optical codified data, such as barcode, EZcode, high capacity color barcode, ShotCode, MaxiCode, GTIN12 code, GTIN-13 code, and Aztec code. In one embodiment, the merchant 106 has sent an electronic bill to the user 104 and the electronic bill includes a QR code. The user 104 is able to open the electronic bill on the electronic device 102 and have the QR code displayed on the GUI. The user 104 then capture a screenshot of the GUI including the QR code and the screenshot is saved on a memory or clipboard of the electronic device 102. Using the “Paste QR” option 382 enables the payment application 110 to read the QR code captured in the screenshot. Accordingly, the step 410 includes capturing optical codified data (QR code) displayed on the GUI of the electronic device 102 to thereby obtain the merchant identification data. In another embodiment, the merchant 106 has sent a paper bill to the user 104 and the paper bill includes a QR code. Using the “Scan QR” option 383 activates a camera of the electronic device 102 to scan the QR code which is then read by the payment application 110. Accordingly, the step 410 includes capturing, with the camera, optical codified data (QR code) displayed on a physical medium (paper bill) to thereby obtain the merchant identification data.

The options 380 for inputting the merchant identification data further include a “Contact List” option 384 and a “Keyboard Entry” option 385. The “Contact List” option 384 allows the user 104 to select the merchant 106 whose details have been stored in a contact list on a memory of the electronic device 102. This option may be applicable for merchants 106 with which the user 104 frequently transacts and has saved their details on the electronic device 102. The merchant identification data can be obtained upon selection of the merchant 106 from the contact list. The “Keyboard Entry” allows the user 104 to manually enter the merchant identification data, such as merchant name and address. This option may be applicable if the user 104 is transacting with the merchant 106 for the first time.

The options 380 for inputting the merchant identification data further include a “Transaction History” option 386 and a “Proximity” option 387. The merchant identification data may be obtained by selection of the merchant 106 based on transaction history data and/or location data of the electronic device 102. In one embodiment, the step 410 includes retrieving transaction history data and/or identifying merchants 106 proximate to the user 104 based on location data of the electronic device 102 to thereby obtain the merchant identification data. The transaction history data may be retrieved from the payment application database 114 and the data allows the user 104 to identify the merchants 106 with which the user 104 frequently transacts. Additionally or alternatively, selection of the merchant 106 may be based on proximity to the user 104. A geolocation module of the electronic device 102 provides the location data of the electronic device 102 and the merchants 106 proximate to or in the vicinity of the user 104 can be identified based on the location data. The step 410 includes selecting the merchant 106 based on the transaction history data and/or proximate merchants 106 to thereby obtain the merchant identification data of the selected merchant 106.

In one embodiment, the user 104 may provide the merchant identification data, or more generally the payee identification data, from text messages stored on the electronic device 102. For example, the options 380 may include an option operable by the user 104 to extract the payee identification data from text messages which are accessible via the “Messages” application icon 306. The text message may contain the payee's contact information as the identification data, such as name, address, and/or phone number.

In a step 412, the user 104 enters the payment amount in the payment amount field 364. The payment amount corresponds to the total charge of the utilities bills. Optionally, the user 104 may predefine an upper limit 365 for the payment amount. In a step 414, the payment application 110 retrieves a set of pre-registered payment instruments 108 of the user 104 from the payment application server 112 and payment application database 114 for the user 104 to select the payment instrument 108 via the digital payment section 360. The payment instruments 108 may be registered by the user 104 during first-time usage of the payment application 110, and the details of the payment instruments 108 are tokenized and stored on the payment application 114. Additionally or alternatively, the payment instruments details are locally stored on the electronic device 102. In one embodiment, in a step 416, the user 104 selects the payment instrument 108 from the set of pre-registered payment instruments 108. In another embodiment, the user 104 manually enters details of the payment instrument 108, such as if the user 104 wants to use a newly-issued credit card.

In some embodiments, the payment instrument 108 is automatically selected from the set of pre-registered payment instruments 108 based on predefined conditions. Some non-limiting predefined conditions include usage frequency, threshold payment amount, and selection of payees 105. In one example, the most frequently used payment instrument 108 is classified as a default and automatically selected for all payment transactions. In another example, a predefined payment instrument 108 is selected if the payment amount provided by the user 104 is above (or below) a predefined threshold payment amount. In another example, a particular payment instrument 108 is selected if the payee identification data identifies the payee 105 as one from a predefined selection of payees 105.

In a step 418, the payment request module 110b of the payment application 110 generates a payment request including the payment transaction details and details of the selected payment instrument 108. The selected payment instrument 108 may be a credit card and the details thereof include the credit card number, holder name, and expiry date. Optionally, before generating the payment request, the method 400 includes an additional step of receiving authentication data from the user 104 for authenticating the selected payment instrument 108. Authentication of the selected payment instrument 108 is based on predefined authentication schemes of the issuer institution of the selected payment instrument 108. The authentication data, such as security code or PIN, provided by the user 104 is included in the payment instrument details and communicated to the payment network 118 for authentication by the issuer institution. The payment request is generated in response to successful authentication of the selected payment instrument 108.

In steps 420 and 422, the payment request module 110b communicates the payment request to the payment network 118, via the payment application server 112, for subsequent processing of the payment transaction. It will be appreciated that the payment transaction details and payment instrument details in the payment request are in accordance with one or more standards for the interchange of transaction messages, such as the ISO 8583 standard. Upon successful processing of the payment transaction, in steps 424 and 426, the payment network 118 communicates a payment response to the electronic device 102, via the payment application server 112, to inform the user 104 of the completed payment transaction. Similarly, in a step 428, the payment network 118 communicates a payment response to the merchant 106, specifically to the merchant server 116, to inform the merchant 106 of the same.

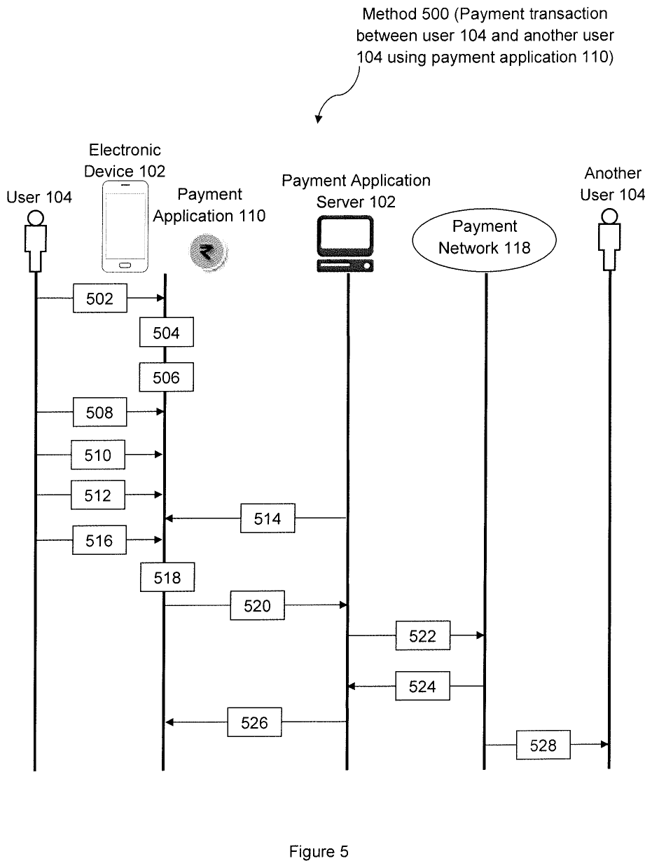

In some embodiments with reference to FIG. 5, there is a computerized method 500 implemented on the electronic device 102 for performing a payment transaction between a user 104 and a payee 105. The user 104 intends to transfer some funds to the payee 105 who is a friend and another user 104 of another electronic device 102. It will be appreciated that various aspects of the method 400 apply similarly or analogously to the method 500 and vice versa, and such aspects are omitted from the description of the method 500 for purpose of brevity.

In a step 502 of the method 500, the user 104 executes the payment application 110 on the electronic device 102. In a step 504, the payment application 110 initiates a user request to perform the payment transaction. In a step 506, the transaction request module 110a presents, in response to initiation of the user request, a user operative interface for the user 104 to provide details of the payment transaction. The user operative interface is exemplified as the payment transaction screen 332. In a step 508, the transaction request module 110a obtains the payment transaction details provided by the user 104 via the payment transaction screen 332.

In a step 510, the user 104 provides the identification data of the payee 105. As the payee 105 is a friend of the user 104, the user 104 may use the “Contact List” option 384 to input the payee identification data, such as mobile number or national identification number. If the user 104 does not have the payee's contact details saved, the user 104 can use the “Keyboard Entry” option 385 to input the mobile number. Alternatively, the user 104 may use the “Proximity” option 387 to identify the payee 105 proximate to the user 104. In this regard, the situation could be the user 104 and the payee 105 are having dinner and the payee 105 has paid for dinner bill to the restaurant. The user 104 wants to return his share of the dinner bill to the payee 105. Instead of searching for the payee's contact in the contact list, the user 104 may search for the payee's electronic device 102 using the “Proximity” option 387. The search may be performed by various wireless short-range communication protocols such as Bluetooth, BLE (Bluetooth Low Energy) NFC, RFID (radio frequency identification) and voice/audio-based recognition. Upon detecting the payee's electronic device 102, the identification data of the payee 105 is communicated to the user's electronic device 102 and read by the payment application 110 at the payee field 362. Yet alternatively, the payee 105 may communicate a text message to the user 104, such as via SMS receivable on the electronic device 102. The text message contains contact information of the payee 105, such as phone number. The payment application 110 then extracts the payee identification data from the text message.

In a step 512, the user 104 enters the payment amount in the payment amount field 364. The payment amount corresponds to his share of the dinner bill. In a step 514, the payment application 110 retrieves a set of pre-registered payment instruments 108 of the user 104. In a step 516, the user 104 selects the payment instrument 108 from the set of pre-registered payment instruments 108.

In a step 518, the payment request module 110b generates a payment request including the payment transaction details and details of the selected payment instrument 108. In steps 520 and 522, the payment request module 110b communicates the payment request to the payment network 118 for subsequent processing of the payment transaction. Upon successful processing of the payment transaction, in steps 524 and 526, the payment network 118 communicates a payment response to the electronic device 102 to inform the user 104 of the completed payment transaction. Similarly, in a step 528, the payment network 118 communicates a payment response to the payee's electronic device 102 to inform the payee 105, who is another user 104, of the same.

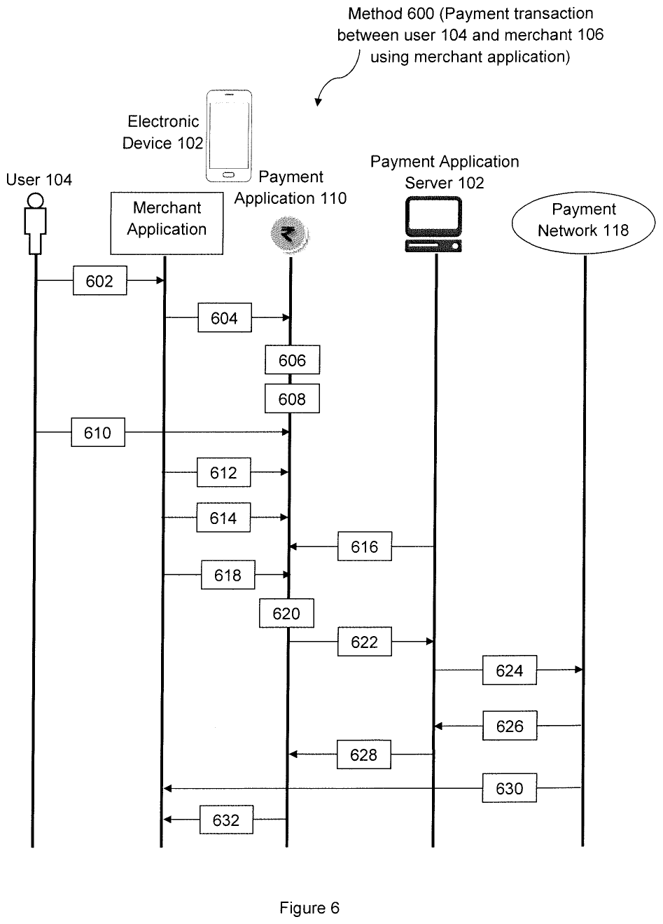

In some embodiments with reference to FIG. 6, there is a computerized method 600 implemented on the electronic device 102 for performing a payment transaction between a user 104 and a payee 105. The payee 105 is a merchant 106 and the user 104 intends to purchase some merchandise online from the merchant 106. The merchant 106 provides a merchant application operative on the electronic device 102 and hosted on the merchant server 116 for the user 104 to browse through the available merchandise online. It will be appreciated that various aspects of the method 400/500 apply similarly or analogously to the method 600 and vice versa, and such aspects are omitted from the description of the method 600 for purpose of brevity.

In a step 602 of the method 600, the user 104 uses the merchant application in cooperation with the merchant server 116 to browse and purchase the merchandise. At the checkout page, the merchant application provides a function similar to the payment application icon 312 that executes the payment application 110 which is cooperative with the merchant application via an API. The API allows the merchant application to access the payment rails/operations provided by the payment application 110. In a step 604, the electronic device 102 processes user input via the merchant application, specifically at the checkout page, to thereby execute the payment application 110. In a step 606, the transaction request module 110a initiates a user request to perform the payment transaction. Optionally, the user request includes user login credentials for verifying the user 104. In a step 608, the transaction request module 110a presents, in response to initiation of the user request, the user operative interface, i.e. the payment transaction screen 332, for the user 104 to provide details of the payment transaction. In a step 610, the transaction request module 110a obtains the payment transaction details provided by the user 104 via the payment transaction screen 332.

In a step 612, the payment application 110 obtains the identification data of the merchant 106. As the payment transaction is initiated via the merchant application, the merchant identification data may be automatically retrieved from the merchant application/merchant server 116 and populated at the payee field 362. Alternatively, the user 104 may use the “Keyboard Entry” option 385 to manually input the merchant identification data, such as merchant name and address.

In a step 614, the payment application 110 obtains the payment amount which corresponds to the total price of the merchandise. As the payment transaction is initiated via the merchant application, the payment amount may be automatically retrieved from the merchant application/merchant server 116 and populated at the payment amount field 364. In a step 616, the payment application 110 retrieves a set of pre-registered payment instruments 108 of the user 104. In a step 618, the user 104 selects the payment instrument 108 from the set of pre-registered payment instruments 108.

In a step 620, the payment request module 110b generates a payment request including the payment transaction details and details of the selected payment instrument 108. In steps 622 and 624, the payment request module 110b communicates the payment request to the payment network 118 for subsequent processing of the payment transaction. Upon successful processing of the payment transaction, in steps 626 and 628, the payment network 118 communicates a payment response to the electronic device 102 to inform the user 104 of the completed payment transaction. Similarly, in a step 630, the payment network 118 communicates a payment response to the merchant 106. In a step 632, the payment application 110 returns to the merchant application to complete the checkout process and merchandise purchase.

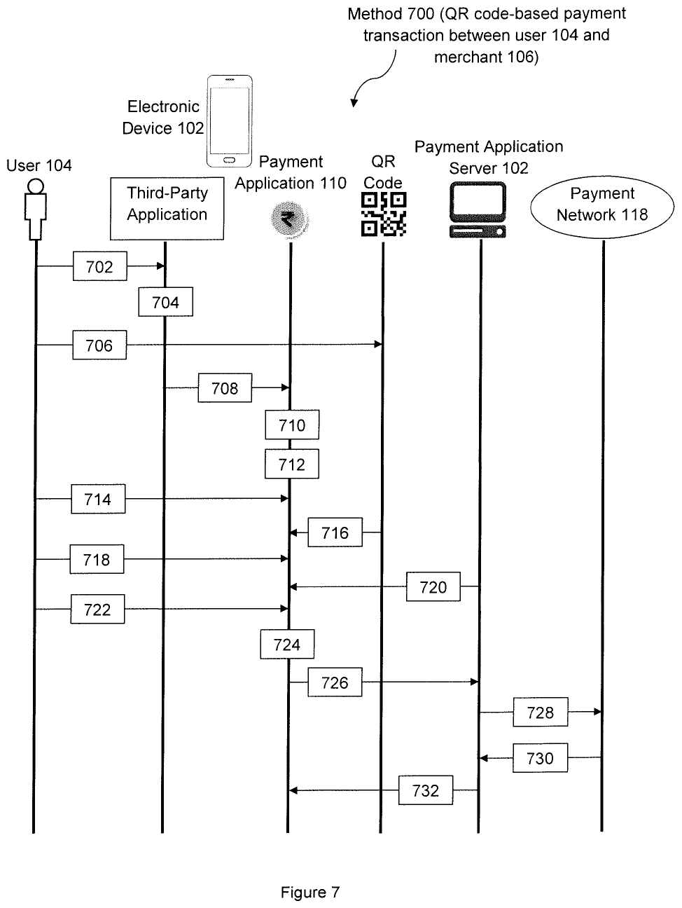

In some embodiments with reference to FIG. 7, there is a computerized method 700 implemented on the electronic device 102 for performing a payment transaction between a user 104 and a payee 105. The payee 105 is a merchant 106 and the user 104 intends to purchase some merchandise from a physical retail store of the merchant 106. The merchant 106 displays a QR code at the merchant store to facilitate customers to obtain the merchant identification data. The QR code may be displayed on a physical medium, such as laminated print, or on an electronic display screen at the merchant store. There is a software application, such as a digital wallet application or a simple QR-reader application (collectively referred to as a third-party application), operative on the electronic device 102 and configured for scanning and capturing QR codes. It will be appreciated that various aspects of the method 400/500/600 apply similarly or analogously to the method 700 and vice versa, and such aspects are omitted from the description of the method 700 for purpose of brevity.

The user 104 is purchasing some merchandise at the merchant store using the electronic device 102. In a step 702 of the method 700, the user 104 executes the third-party application to pay for the merchandise. In a step 704, the third-party application activates the camera of the electronic device 102. In a step 706, the user 104 uses the camera to capture the QR code displayed at the merchant store. In a step 708, the third-party application detects the user input of the captured QR code and executes the payment application 110 cooperative therewith via the API. In a step 710, the transaction request module 110a initiates a user request to perform the payment transaction. In a step 712, the transaction request module 110a presents, in response to initiation of the user request, the user operative interface, i.e. the payment transaction screen 332, for the user 104 to provide details of the payment transaction. In a step 714, the transaction request module 110a obtains the payment transaction details provided by the user 104 via the payment transaction screen 332.

In a step 716, the payment application 110 obtains the identification data of the merchant 106. Specifically, the merchant identification data is obtained from the captured QR code and populated at the payee field 362. In a step 718, the user 104 enters the payment amount in the payment amount field 364. The payment amount corresponds to the total price of the merchandise. In a step 720, the payment application 110 retrieves a set of pre-registered payment instruments 108 of the user 104. In a step 722, the user 104 selects the payment instrument 108 from the set of pre-registered payment instruments 108.

In a step 724, the payment request module 110b generates a payment request including the payment transaction details and details of the selected payment instrument 108. In steps 726 and 728, the payment request module 110b communicates the payment request to the payment network 118 for subsequent processing of the payment transaction. Upon successful processing of the payment transaction, in steps 730 and 732, the payment network 118 communicates a payment response to the electronic device 102 to inform the user 104 of the completed payment transaction. Similarly, the payment network 118 communicates a payment response to the merchant 106 to inform the merchant 106 of the same.

It will be appreciated that various aspects of the method 700 in relation to obtaining merchant identification data from QR codes are applicable to the “Scan QR” option 383 of the payment application 110. Additionally, the captured QR code may be saved as a digital image on the electronic device 102, and is usable for future payment transactions with the same merchant 106 by using the “Paste QR” option 382. In some alternative embodiments, the merchant 106 may not have a QR code or other optical codified data displayed at the merchant store. Instead, the merchant 106 may operate a merchant billing machine or POS terminal at the merchant store that is NFC-enabled to communicate the merchant identification data to the electronic device 102 via NFC.

In many embodiments described above, the fields 362, 364, and 366 of the digital payment section 360 are individually input by the user 104 to provide the basic details required for making payment—payee identity, amount to pay, and payment mode. In some embodiments, input at one or more of the fields 362, 364, and 366 may auto-populate the remaining fields. For example, if the user 104 frequently uses a specific payment instrument 108 for a specific merchant 106, providing the merchant identification data of the specific merchant 106 at the payee field 362 may result in the payment mode field being auto-populated with the specific payment instrument 108. Additionally, if the specific merchant 106 is a subscription service provider that bills fixed recurring payments to the user 104, the fixed recurring payment amount may be auto-populated at the payment amount field 364.

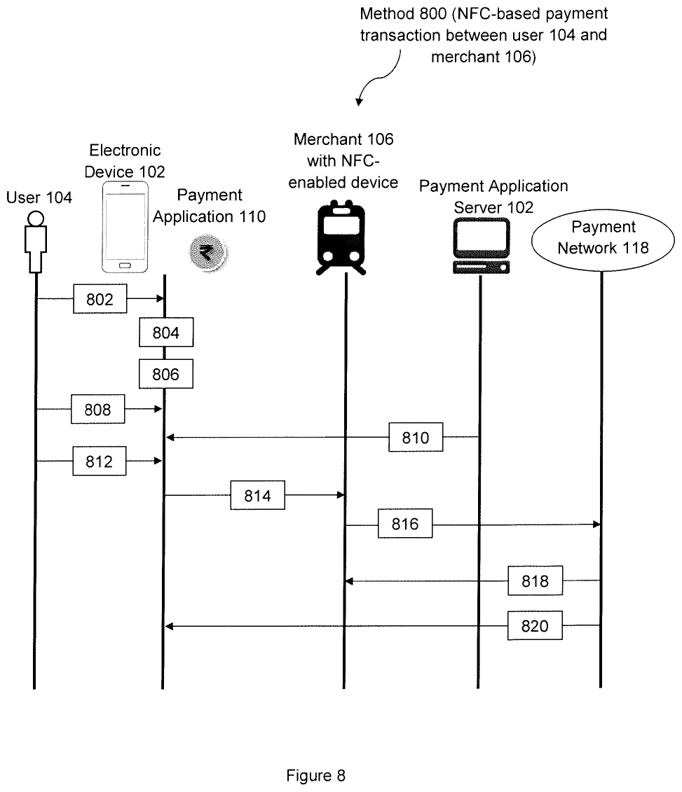

In some embodiments, the payment application 110 may be used for NFC-based payments. With reference to FIG. 8, there is a computerized method 800 implemented on the electronic device 102 for performing a payment transaction between a user 104 and a payee 105. The payee 105 is a merchant 106 such as a transport service provider and the user 104 intends to pay for a commuting service, e.g. the Pune Metro provided by merchant 106. The merchant 106 operates a device, e.g. a gantry, at one of the metro stations/terminals where the user 104 is boarding. The gantry is NFC-enabled or is implemented with an NFC reader such that the gantry is communicable with the electronic device 102 via NFC.

It will be appreciated that various aspects of the method 400/500/600/700 apply similarly or analogously to the method 800 and vice versa, and such aspects are omitted from the description of the method 800 for purpose of brevity. In a step 802 of the method 800, the user 104 executes the payment application 110. In a step 804, the transaction request module 110a of the payment application 110 initiates a user request to perform the payment transaction. In a step 806, the transaction request module 110a presents, in response to initiation of the user request, the user operative interface, i.e. the payment transaction screen 332, for the user 104 to provide details of the payment transaction. In a step 808, the transaction request module 110a obtains the payment instrument 108 details provided by the user 104. Specifically, the user 104 provides the payment instrument details at the NFC payment section 340 of the payment transaction screen 332.

With reference to FIG. 3F, the NFC payment section 340 includes a payment mode field 342 for selecting the payment instrument 108. In a step 810, the payment application 110 retrieves a set of pre-registered payment instruments 108 of the user 104. In a step 812, the user 104 selects the payment instrument 108 from the set of pre-registered payment instruments 108. For example, the selected payment instrument 108 is a prepaid or stored-value card for use on the Pune Metro. The NFC payment section 340 includes a type 344 that identifies the type of payment instrument 108, and a balance field 346 that displays the current stored balance of the selected payment instrument 108. The NFC payment section 340 further includes a status indicator 348 that indicates if the selected payment instrument 108 is activated or deactivated for use at the NFC-enabled gantry. Optionally, the selected payment instrument 108 is activated in response to authentication thereof by the payment network 118.

In a step 814, the user 104 taps the electronic device 102 in front of the NFC-enabled gantry, thereby communicating the details of the activated payment instrument 108 to the merchant 106. In a step 816, the merchant 106 communicates the payment instrument details to the payment network 118 for subsequent processing the payment transaction, as will be readily understood by the skilled person. Upon successful processing of the payment transaction, the gantry opens and permits the user 104 to enter. In steps 818 and 820, the payment network 118 communicates payment responses to the merchant 106 and the electronic device 102 to inform the user 104 of the completed payment transaction.

It will be appreciated that the method 800 is similarly applicable for payment transactions with merchants 106 at merchant stores with NFC-enabled merchant billing machines or POS terminals.

The electronic device 102 and method 200 advantageously provides a payment application 110 that is versatile for the user 104 to perform payment transactions with various payees 105, particularly merchants 106. The payment application 110 provides a user operative interface for the user 104 to provide the payment transaction details which include the merchant identification data and payment amount, as well as details of a selected payment instrument 108 for payment of the payment transaction. The basic details required for making payment in all payment transactions are provided by the user 104. The payment application 110 thus shifts control of parameters of payment transactions from the merchants 106 to the users 104 and empowers the users 104 with greater flexibility in payment transactions. This potentially mitigates risk of inaccurate payment transactions, such as if the merchant 106 indicated a wrong payment amount and the user 104 did not spot the mistake. Moreover, risk of fraudulent payment transactions may be mitigated as the user 104 does not need to present the payment instrument 108, e.g. physical credit card, to the merchant 106, since all communication is performed via the payment application 110.

Another advantage is that the payment application 110 can be used to make payments to payees 105 who are individuals and other users 104 of the payment application 110. Various options are provided by the user operative interface to help the user 104 provide the payee identification data. Such options include the use of QR codes, existing contacts of the user 104, and searching for nearby payees 105. The user 104 would not need to always manually input the payee identification data, which can be cumbersome and time-consuming, especially if the user 104 needs to make an urgent payment such as an almost-late bill payment. Use of existing contacts and nearby payees 105 allows the user 104 to quickly identify the payees 105, such as for sharing a dinner bill with friends.

The payment application 110 may be considered as a generic/common/default application, such as integrally operative as part of the operating system, that can be easily executed and used by the user 104 for various payment purposes. Other applications operative on the electronic device 102 may implement the payment rails or services provided by the payment application 110, via the API, to facilitate performing of payment transactions via the other applications. The payment application icon 312 can be placed on the home screen 302 to advantageously help the user 104 to easily locate and conveniently access the payment application 110. This obviates the need to have separate payment icons of various payment-related applications, such as merchant applications and digital wallet applications on the home screen 302. Consequently, the user 104 can conveniently reduce the number of icons at the home screen 302 to the minimum frequently-used ones, which will in turn minimize the time to locate a required icon at the time of need and mitigate confusion.

### Technical Architecture

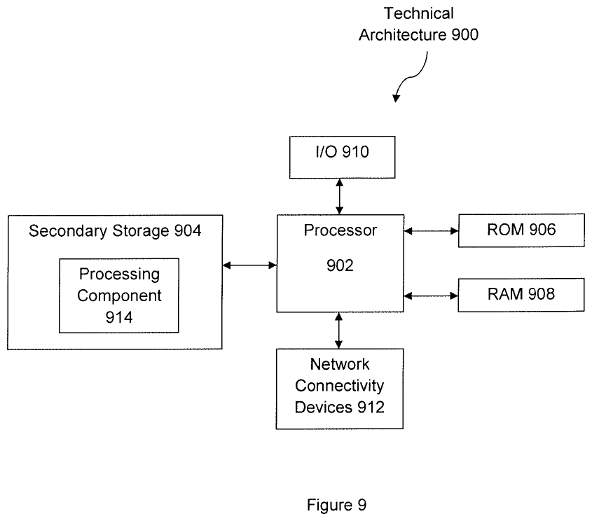

FIG. 9 is a block diagram illustrating a technical architecture 900 of the electronic device 102. The payment application server 112 and merchant server 116 may share a similar technical architecture. As used herein, a server is a physical or cloud data processing system on which a server program runs. The server may be implemented in hardware or software, or a combination thereof. The server includes computers, laptops, mini-computers, mainframe computers, any non-transient and tangible machines that can execute a machine-readable code, cloud-based servers, distributed server networks, and a network of computer systems.

The technical architecture 900 includes a processor 902 (also referred to as a central processor unit or CPU) that is in communication with memory devices including secondary storage 904 (such as disk drives or memory cards), read-only memory (ROM) 906, and random-access memory (RAM) 908. The processor 902 may be implemented as one or more CPU chips. Various modules or components for performing various operations or steps of the methods 200 to 800 are configured as part of the processor 902 and such operations or steps are performed in response to non-transitory instructions operative or executed by the processor 902. The processor 902 includes suitable logic, circuitry, and/or interfaces to execute such operations or steps. Some non-limiting examples of the processor 902 include an application-specific integrated circuit (ASIC) processor, a reduced instruction set computing (RISC) processor, a complex instruction set computing (CISC) processor, a field-programmable gate array (FPGA), and the like.

The technical architecture 900 further includes input/output (I/O) devices 910, and system connectivity/network devices 912. The secondary storage 904 typically includes one or more memory cards, disk drives, tape drives, or other storage devices and is used for non-volatile storage of data and as an over-flow data storage device if RAM 908 is not large enough to hold all working data. Secondary storage 904 may be used to store programs which are loaded into RAM 908 when such programs are selected for execution.

The secondary storage 904 has a processing component 914 including non-transitory instructions operative by the processor 902 to perform various operations or steps of the methods 200 to 800 according to various embodiments of the present disclosure. The ROM 906 is used to store instructions and perhaps data which are read during program execution. The secondary storage 904, the ROM 906, and/or the RAM 908 may be referred to in some contexts as computer-readable storage media and/or non-transitory computer-readable media. Non-transitory computer-readable media include all computer-readable media, with the sole exception being a transitory propagating signal per se.

The I/O devices 910 may include printers, video monitors, liquid crystal displays (LCDs), plasma displays, touch screen displays, keyboards, keypads, switches, dials, mice, track balls, voice recognizers, card readers, paper tape readers, and/or other known input devices.

The system connectivity/network devices 912 may take the form of modems, modem banks, Ethernet cards, universal serial bus (USB) interface cards, serial interfaces, token ring cards, fiber distributed data interface (FDDI) cards, wireless local area network (WLAN) cards, radio transceiver cards that promote radio communications using protocols such as code division multiple access (CDMA), global system for mobile communications (GSM), long-term evolution (LTE), worldwide interoperability for microwave access (WiMAX), near field communication (NFC), radio frequency identity (RFID), and/or other air interface protocol radio transceiver cards, and other known system connectivity/network devices. These system connectivity/network devices 912 may enable the processor 902 to communicate with the Internet or one or more intranets. With such a system/network connection, it is contemplated that the processor 902 might receive information from the network, or might output information to the network in the course of performing the operations or steps of the methods 200 to 800. Such information, which is often represented as a sequence of instructions to be executed using processor 902, may be received from and outputted to the network, for example, in the form of a computer data signal embodied in a carrier wave.

The processor 902 executes instructions, codes, computer programs, scripts which it accesses from hard disk, floppy disk, optical disk (these various disk-based systems may all be considered secondary storage 904), flash drive, ROM 906, RAM 908, or the system connectivity/network devices 912. While only one processor 902 is shown, multiple processors may be present. Thus, while instructions may be discussed as executed by a processor, the instructions may be executed simultaneously, serially, or otherwise executed by one or multiple processors.

The technical architecture 900 may be formed by one computer, or multiple computers in communication with each other that collaborate to perform a task. For example, but not by way of limitation, an application may be partitioned in such a way as to permit concurrent and/or parallel processing of the instructions of the application. Alternatively, the data processed by the application may be partitioned in such a way as to permit concurrent and/or parallel processing of different portions of a data set by the multiple computers. In an embodiment, virtualization software may be employed by the technical architecture 900 to provide the functionality of a number of servers that is not directly bound to the number of computers in the technical architecture 900. In an embodiment, the functionality disclosed above may be provided by executing the application and/or applications in a cloud computing environment. Cloud computing may include providing computing services via a system/network connection using dynamically scalable computing resources. A cloud computing environment may be established by an enterprise and/or may be hired on an as-needed basis from a third-party provider.

It is understood that by programming and/or loading executable instructions onto the technical architecture 900, at least one of the CPU 902, ROM 906, and RAM 908 are changed, transforming the technical architecture 900 in part into a specific purpose machine or apparatus having the functionality as taught by various embodiments of the present disclosure. It is fundamental to the electrical engineering and software engineering arts that functionality that can be implemented by loading executable software into a computer can be converted to a hardware implementation by known design rules.

Furthermore, various embodiments of the present disclosure may be implemented as a method, apparatus, or article of manufacture using standard programming and/or engineering techniques to produce software, firmware, hardware, or any combination thereof to control a computer to implement the disclosed embodiments. For instance, various embodiments may be implemented as a computer-readable medium embedded with a computer-executable program, which encompasses a computer program accessible from any computer-readable storage device or storage media. For example, computer-readable media can include but are not limited to magnetic storage devices (e.g. hard disk, floppy disk, or magnetic strips), optical discs (e.g. compact disc (CD), digital versatile disc (DVD), or Blu-ray disc), smart cards, flash memory devices (e.g. card, stick, or key drive), and solid state drives/memory devices.

In the foregoing detailed description, embodiments of the present disclosure in relation to an electronic system and computerized method for performing payment transactions are described with reference to the provided figures. The description of the various embodiments herein is not intended to call out or be limited only to specific or particular representations of the present disclosure, but merely to illustrate non-limiting examples of the present disclosure. The present disclosure serves to address at least one of the mentioned problems and issues associated with the prior art. Although only some embodiments of the present disclosure are disclosed herein, it will be apparent to a person having ordinary skill in the art in view of this disclosure that a variety of changes and/or modifications can be made to the disclosed embodiments without departing from the scope of the present disclosure. Therefore, the scope of the disclosure as well as the scope of the following claims is not limited to embodiments described herein.

1. An electronic device for performing a payment transaction between a user and a payee, the electronic device configured for executing a payment application operative on the electronic device, the payment application comprising:
a transaction request module configured for:
initiating a user request to perform the payment transaction;
presenting, in response to initiation of the user request, a user operative interface for the user to provide details of the payment transaction;
obtaining, via the user operative interface, the payment transaction details comprising payee identification data and a payment amount; and
selecting, by the user via the user operative interface, a payment instrument of the user for payment of the payment amount to the payee; and
a payment request module configured for:
generating a payment request comprising the payment transaction details and selected payment instrument details; and
communicating the payment request to a payment network for subsequent processing of the payment transaction,
wherein the user operative interface provides a plurality of options for the user to provide the payee identification data.

2. The electronic device according to claim 1, wherein the payment application is integrally operative as part of an operating system of the electronic device.

3. The electronic device according to claim 2, wherein the payment application is executed in response to user activation of a payment application icon displayed on a graphical user interface of the electronic device.

4. The electronic device according to claim 1, wherein the payment application is cooperative, via an application programming interface, with other application(s) operative on the electronic device.

5. The electronic device according to claim 4, wherein the payment application is executed in response to processing user input via the other application(s).

6. The electronic device according to claim 1, wherein the plurality of options relate to one or more of optical codified data, contacts stored on the electronic device, transaction history, and proximity to the user.

7. The electronic device according to claim 1, wherein obtaining the payee identification data comprises capturing optical codified data displayed on a graphical user interface of the electronic device or on a physical medium.

8. The electronic device according to claim 1, wherein the payee identification data is obtained by selection of the payee based on transaction history data and/or location data of the electronic device.

9. The electronic device according to claim 1, wherein the payment instrument is selected by the user from a set of pre-registered payment instruments of the user.

10. A computerized method for performing a payment transaction between a user and a payee, the method performed by an electronic device of the user and comprising executing a payment application operative on the electronic device, the payment application thereby performing steps comprising:
initiating a user request to perform the payment transaction;
presenting, in response to initiation of the user request, a user operative interface for the user to provide details of the payment transaction;
obtaining, via the user operative interface, the payment transaction details comprising payee identification data and a payment amount;
selecting, by the user via the user operative interface, a payment instrument of the user for payment of the payment amount to the payee;
generating a payment request comprising the payment transaction details and selected payment instrument details; and
communicating the payment request to a payment network for subsequent processing of the payment transaction,
wherein the user operative interface provides a plurality of options for the user to provide the payee identification data.

11. The method according to claim 10, further comprising activating, by the user, a payment application icon displayed on a graphical user interface of the electronic device to thereby execute the payment application, wherein the payment application is integrally operative as part of an operating system of the electronic device.

12. The method according to claim 10, further comprising processing user input via other application(s) operative on the electronic device to thereby execute the payment application, wherein the payment application is cooperative, via an application programming interface, with the other application(s).

13. The method according to claim 10, further comprising capturing, with a camera of the electronic device, optical codified data displayed on a physical medium to thereby obtain the payee identification data.

14. The method according to claim 10, further comprising capturing optical codified data displayed on a graphical user interface of the electronic device to thereby obtain the payee identification data.

15. The method according to claim 10, further comprising retrieving transaction history data and/or identifying payees proximate to the user based on location data of the electronic device to thereby obtain the payee identification data.

16. The method according to claim 15, further comprising selecting the payee based on the transaction history data and/or proximate payees to thereby obtain the payee identification data of the selected payee.

17. The method according to claim 10, further comprising retrieving a set of pre-registered payment instruments of the user for selecting the payment instrument.

18. The method according to claim 17, further comprising automatically selecting the payment instrument from the set of pre-registered payment instruments based on predefined conditions.

19. The method according to claim 10, further comprising receiving authentication data from the user for authenticating the selected payment instrument before generating the payment request.

20. A non-transitory computer-readable storage medium having stored thereon computer-readable instructions that, when executed, cause an electronic device to perform steps of a computerized method according to claim 10.
